(19) United States
(12) Patent Application Publication
(10) Pub. No.: US 2009/0301984 A1
(43) Pub. Date: Dec. 10, 2009

(54) MOVABLE PULLEY HEADS FOR A LATERAL SPREADER MOVEMENT

(75) Inventors: Miguel Angel Tavio Diaz, San Roque (ES); Manoli Vilchez Vilchez, Algeciras (ES); Antonio Illana Martos, Algeciras (ES)

Correspondence Address: CANTOR COLBURN, LLP, 20 Church Street, 22nd Floor, Hartford, CT, 06103, US

(73) Assignee: Maersk Espana S.A, Algeciras (ES)

(21) Appl. No.: 12/092,344

(22) PCT Filed: Jul. 20, 2006
(86) PCT No.: PCT/ES06/00422

§ 371 Date: Oct. 14, 2008

(30) Foreign Application Priority Data
Nov. 3, 2005 (ES) P200502752

(51) Int. Cl. B66C 19/00

(52) U.S. Cl. 212/328

(57) ABSTRACT

Movable pulley head assembly for a lateral spreader movement, where the lateral movement of the spreader is carried out directly on hoist pulley assemblies, the assembly including structurally rigid bridges where a beam of the bridge is long enough for the travel of the mechanism, cross members attached to pulley heads, where each cross member supports a bridge at each end by means of elements allowing relative movement between bridge and cross member, where the cross members can be extended outside the bridges to serve as support for other elements or mechanisms, the assembly further including worm screws for the lateral movement of the spreader.

### TECHNICAL FIELD OF THE INVENTION

The invention generally concerns transport and movement of containers and particularly relates to a spreader.

### BRIEF DESCRIPTION OF RELATED ART

Lateral spreader movement systems used up until now are all based on the use of a heavy rigid frame connected to the pulley head and mobile in relation to the lower part for engaging the load. An actuator such as a cylinder or chain motor drive is used.

The lower part moves supported on carriages with wheels, rollers or skids.

The known main variants are:
A hydraulic cylinder, four carriages (one in each corner), each carriage with four wheels. The treadway is the flanges of the rolled profiles welded to one another by means of cross members forming the frame. It is a system with poor resistance to forward movement by highly hyperstatic and has many elements due to the abundance of wheels.
A hydraulic cylinder, four rollers (one in each corner). Each roller can receive a significant load, therefore its axle must be dually supported. This makes it necessary to use a very bulky frame.
A motor driven drive chain supported on skids, rollers or pulleys.

Container-handling cranes present the problem of precisely adjusting the position for engaging the container with the spreader. The lateral movement in relation to the container (longitudinal in relation to the crane) is obtained by means of the movement of the carriage. However the longitudinal movement in relation to the container requires an additional mechanism, or by default moving the entire crane (see FIG. 1).

The movement of the gantry is not advisable in approach maneuvers with adjustment runs in a range of centimeters. These maneuvers are more gently and precisely obtained by using a spreader which allows laterally moving the container in relation to the gripping points of the hoist cables.

The lateral movement mechanism requires the spreader to have two parts mobile in relation to one another. The upper part is connected to the pulley head of the hoist cables, and the lower part has the elements for engaging the load.

### BRIEF SUMMARY OF THE INVENTION

The rigid upper frame is replaced by four independent and much smaller and more lightweight bridges. The pulley head is fixed to a part (cross member) which transmits the load by means of a support on skids or rollers. Two cross members are used, one on each end. The bridges are integral with the lower part, surrounding the ends of the cross members on which they rest by means of skids or rollers. Relative movement between both parts of the spreader is obtained by moving the cross members in relation to the bridges.

Operation can be achieved in very different ways. In any case a multi-actuator system is required which assures movement of the four support points of the load at the same time.

Worm screws are used as a drive element, which entails another novelty of the proposed system. The screw is housed and supported by the bridge, the nut is housed in the cross member such that it can absorb misalignments.

When the crane is positioned over the pile, the spreader must longitudinally coincide with the container. This can be obtained in two ways: moving the gantry or laterally moving the spreader. Movement of the gantry is not advisable in small approach maneuvers, obtaining gentler and more precise maneuvers using a spreader which allows being laterally moved in relation to the crane, preventing intermitting starts and stops which are detrimental to translation transmission.

Some of the features of the described system are: Four operating points coordinated by means of hydraulic valves. A large and heavy frame, which is necessary when a single operating point is used, is eliminated. Power drive screws actuated by small and lightweight motors are used, assuring smooth and self-blocking running.

### BRIEF DESCRIPTION OF THE DRAWINGS

FIG. 1 shows how the container is perpendicular to the longitudinal axis of the crane. The main movement of the container is carried out according to said axis and is achieved by means of the movement of the carriage with the immobile gantry.

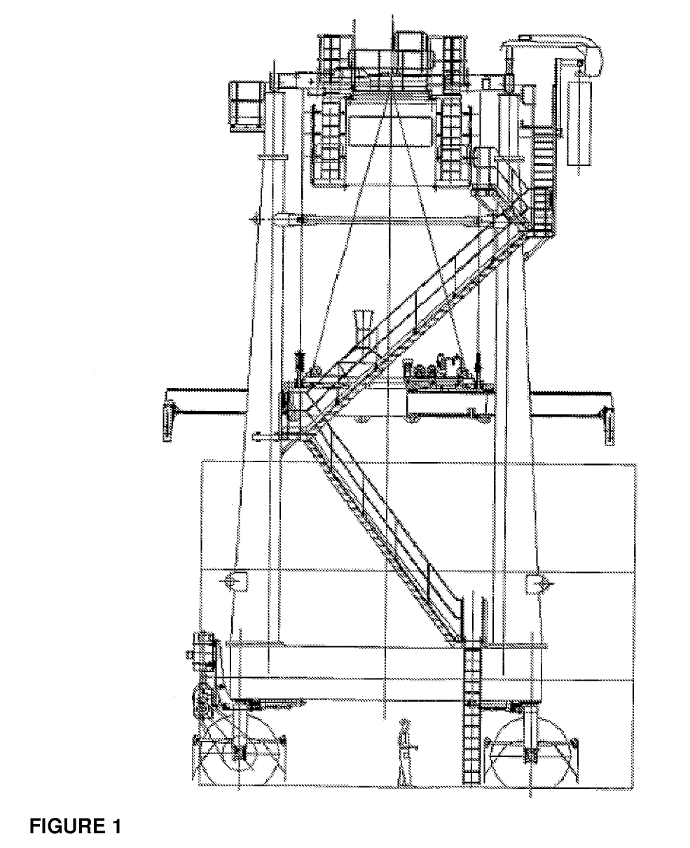

Lateral movement (in relation to the crane) can be obtained in two ways: by movement of the gantry and by movement of the spreader.

FIG. 2 shows the described solution: two cross members and four bridges allowing the lateral movement of the spreader in relation to the pulleys.

FIG. 3 shows an embodiment of the invention.

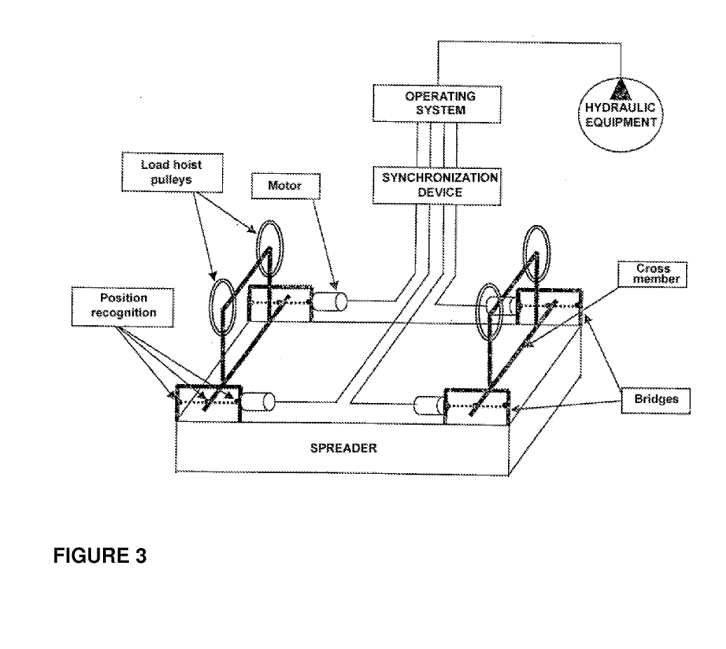

### DETAILED DESCRIPTION OF THE INVENTION

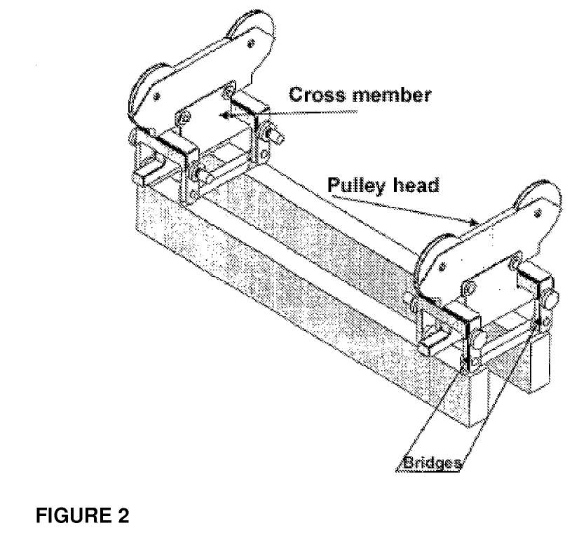

FIG. 2 shows the described solution. The need for a large, rigid and very heavy frame has been eliminated, replacing it with two links—the cross members-operated by four synchronously rotating screws.

Existing pulley heads are used in this specific application. This is not a significant detail, in fact the pulleys are preferably integrated in the cross member, eliminating the current head and converting the cross member into a block.

Whatever the case, the cross member supports the load by means of support elements which allow movement between the cross member and the bridge. Rollers, balls, sliding skids, etc. can be used. It is appropriate for said elements to rest on a joint support, assuring that the pressure is uniform, preventing breaks due to overload or uneven wear (in the case of skids). For this reason, a system using skids made of a self-lubricating synthetic material, directly coupled on the axial joint, has been provided.

The cross member has two types of contact areas of interest. On one hand, each skid is in contact with a sliding sheet to that effect, located in the lower part of the beam of the bridge. This area supports the load with large magnitude compression forces. On the other hand, the cress member serves as a housing for the nut of the worm screw such that it receives the axial thrust force thereof, responsible for overcoming the slide resistance of the skids (or rolling resistance in balls and rollers).

The location of the worm screws and of the thrust nuts is not significant. The nuts can be housed in any point of the cross member. Four screws have been used, supported and housed in the bridges for reasons of compactness and protection of the mechanism. However, they could be located on supports to that effect integral with the structure of the lower frame. Solutions with two screws, each located in the center of the cross members, could also be provided but they would not assure perfectly aligned movement.

1. Movable pulley head assembly for a lateral spreader movement, where the lateral movement of the spreader is carried out directly on hoist pulley assemblies, the assembly comprising:
structurally rigid bridges where a beam of the bridge is long enough for the travel of the mechanism;
cross members attached to pulley heads, where each cross member supports a bridge at each end by means of elements allowing relative movement between bridge and cross member;
wherein the cross members can be extended outside the bridges to serve as support for other elements or mechanisms;
the assembly further comprising worm screws for said lateral movement of the spreader.

2. The assembly of claim 1, wherein the assembly is configured for controlled operation such that any movement value within maximum travel can be obtained.

3. The assembly of claim 1, wherein the worm screws are operated by means of one or several motors.

4. The assembly of claim 1, wherein said actuators comprise a control and synchronization system.

5. The assembly of claim 4, wherein said control system is configured to provide for independent running of the actuators.
